(19) United States
(12) Patent Application Publication
(10) Pub. No.: US 2008/0280208 A1
(43) Pub. Date: Nov. 13, 2008

(54) ELECTROCHEMICAL DEVICE AND PRODUCTION METHOD THEREOF

(75) Inventors: Katsuo NAOI, Tokyo (JP); Kenji NISHIZAWA, Tokyo (JP); Yoshihiko OHASHI, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/114,356

(22) Filed: May 2, 2008

(30) Foreign Application Priority Data
May 11, 2007 (JP) 2007-127232

(51) Int. Cl. H01M 2/16; H01M 4/82

(52) U.S. Cl. 429/247; 29/623.1

(57) ABSTRACT

An electrochemical device including a first anode, a first cathode, a single continuous separator provided between the first anode and the first cathode and folded so as to be arranged on the opposite side of the first anode to the first cathode and on the opposite side of the first cathode to the first anode, and an electrolyte in contact with the separator, the first anode and the first cathode, wherein the separator has a shape that surrounds the periphery of the first anode or the first cathode by being folded in the same direction at two folds consecutive from one end of the separator.

### BACKGROUND OF INVENTION

1. Field of the Invention

The present invention relates to an electrochemical device such as a secondary battery or electrochemical capacitor, and to a production method thereof.

2. Related Background Art

Known examples of separators provided between a pair of electrodes in a conventional rectangular (sheet-like) electrochemical capacitor or lithium ion secondary battery include laminated types consisting of individual layers of discontinuous separators and folded types in which a single continuous separator is folded in a zigzag pattern (see, for example, Japanese Patent Application Laid-open Nos. 2002-329530, H7-57716 and H7-142086 and Published Japanese Translation No. 2004-503055 of a PCT International Publication).

However, electrochemical devices using a laminated separator have poor work efficiency during production as a result of requiring the laminating of individual separators. In addition, since separators are only present above and below the electrodes, the electrodes may shift in the horizontal direction causing a short circuit.

On the other hand, electrochemical devices using a separator folded in a zigzag pattern have improved work efficiency during production as compared with those using a laminated separator. However, even in the case of using a zigzag-folded separator, the electrodes may still shift in the horizontal direction causing a short circuit.

### SUMMARY OF THE INVENTION

With the foregoing in view, an object of the present invention is to provide an electrochemical device resistant to the occurrence of short circuiting and a production method thereof.

In order to achieve the above-mentioned object, the present invention provides an electrochemical device comprising: a first anode, a first cathode, a single continuous separator provided between the first anode and the first cathode and folded so as to be arranged on the opposite side of the first anode to the first cathode and on the opposite side of the first cathode to the first anode, and an electrolyte in contact with the separator, the first anode and the first cathode; wherein, the separator has a shape that surrounds the periphery of the first anode or the first cathode by being folded in the same direction at two folds consecutive from one end of the separator.

In the present invention, the terms “anode” and “cathode” are determined based on the polarity of the electrochemical device during discharge for the sake of convenience in the explanation. Thus, during charging, the “anode” becomes the “cathode”, while the “cathode” becomes the “anode”.

In this electrochemical device, the shape of the separator differs from the shape of a zigzag fold in which the folds are bent back in mutually opposite directions, and by employing a shape in which the separator is folded in the same direction at two consecutive folds, a structure results in which the periphery of either the first anode or the first cathode is surrounded by the separator. Consequently, an electrode surrounded by the separator is adequately prevented from shifting in the horizontal direction, and the occurrence of short circuiting between this electrode and another opposing that electrode with the separator there between is adequately suppressed. Thus, an electrochemical device of the present invention using a separator having the shape described above is able to adequately suppress the occurrence of short circuiting in comparison with the case of using a conventional laminated separator or zigzag folded separator.

In addition, since the separator in the present invention as described above or a conventional zigzag folded separator are formed by folding a single separator, force is easily generated that causes these separators to return to their original shape prior to folding. In the case of a conventional zigzag folded separator, since the separator is folded in opposite directions at two consecutive folds, the force that causes the separator to return to its original shape is the sum of the two folds, and this force acts in the direction of lamination of the electrodes and separator. In contrast, in the separator in the present invention as described above, since the separator is folded in the same direction at two consecutive folds, the force that causes the separator to return to its original shape is not the sum of the two folds, but rather is less than the force in the case of zigzag folding. Consequently, according to an electrochemical device using a separator in the present invention as described above, the force that causes the separator to return to its original shape is decreased as compared with the case of using a zigzag folded separator, occurrence of shifting of the electrodes is suppressed, and the occurrence of short circuiting is adequately suppressed.

Moreover, at least one end of the separator in the present invention as described above is wrapped inside the folded separator. Although shifting of the electrodes and separator and the resulting short circuiting occur easily at the ends of the separator, as a result of at least one end of this separator being inserted inside the separator, it is possible to adequately suppress the occurrence of electrode shifting and the occurrence of short circuiting attributable thereto in comparison with the case of using a conventional laminated separator or zigzag folded separator.

In addition, an electrochemical device of the present invention is preferably provided with a second cathode arranged on the outer peripheral surface of the separator so as to oppose the first anode, with the separator interposed therebetween, and/or a second anode arranged on the outer peripheral surface of the separator so as to oppose the first cathode, with the separator interposed therebetween.

As a result of the second anode and/or second cathode being provided on the outer peripheral surface of the separator, the occurrence of short circuiting is adequately suppressed while also being able to improve the volume energy density of the electrochemical device, thereby contributing to the realization of reduced size and a thinner shape.

In addition, an electrochemical device of the present invention is preferably provided with two or more of the first anode and/or first cathode, and the separator preferably has a shape that surrounds the periphery of the first anode or the first cathode by being folded in the same direction at two folds consecutive from the other end on the opposite side to the above-mentioned one end of the separator.

As has been described above, as a result of employing a structure in which the periphery of the first anode and/or first cathode is surrounded by a separator at both ends of the separator, electrodes surrounded by both ends of the separator are prevented from shifting in the horizontal direction, thereby adequately suppressing the occurrence of short circuiting between this electrode and another electrode in opposition thereto with the separator interposed there between. In addition, since the shape of the separator is such that both ends of the separator are wrapped inside the bent separator, shifting of the electrodes and separator, which occurs easily at the ends of the separator, as well as the occurrence of short circuiting caused thereby, are adequately suppressed. Thus, an electrochemical device of the present invention having the structure described above is able to more adequately suppress the occurrence of short circuiting as compared with the case of using a conventional laminated separator or zigzag folded separator.

In addition, the present invention provides an electrochemical device comprising: a first unit having a first anode, a first cathode, a single continuous separator provided between the first anode and the first cathode and folded so as to be arranged on an opposite side of the first anode to the first cathode and on an opposite side of the first cathode to the first anode, a second cathode arranged on the outer peripheral surface of the separator so as to oppose the first anode with the separator interposed therebetween, and an electrolyte in contact with the separator, the first anode, the first cathode and the second cathode, the separator having a shape that surrounds the periphery of the first anode or the first cathode by being folded in the same direction at two folds consecutive from one end of the separator; a second unit having a first anode, a first cathode, a single continuous separator provided between the first anode and the first cathode and folded so as to be arranged on an opposite side of the first anode to the first cathode and on an opposite side of the first cathode to the first anode, a second anode arranged on the outer peripheral surface of the separator so as to oppose the first cathode with the separator interposed therebetween, and an electrolyte in contact with the separator, the first anode, the first cathode and the second anode, the separator having a shape that surrounds the periphery of the first anode or the first cathode by being folded in the same direction at two folds consecutive from one end of the separator, the electrochemical device having a structure in which the first unit and second unit are alternately laminated.

Since the first and second units of this electrochemical device each have the shape of the separator in the present invention as explained above, the occurrence of short circuiting is adequately suppressed. According to the electrochemical device as described above in which a plurality of units are laminated, the capacity of the electrochemical device can be increased while suppressing the occurrence of short circuiting.

In addition, in the electrochemical device of the present invention, the two folds continuous from the ends of the separator are preferably formed at equal intervals.

As a result of the separator being folded at folds formed at equal intervals (for each predetermined interval) in this manner, the separator is suppressed from being too short or too long (and particularly at the ends thereof), thereby enabling the occurrence of short circuiting to be adequately suppressed while also being advantageous for reducing the size of the electrochemical device.

In addition, in the electrochemical device of the present invention, severed portions and non-severed portions are preferably arranged in the folds of the separator, along said folds.

As a result, bending at the folds becomes easier enabling the separator to be folded accurately for each predetermined interval. Consequently, the separator is suppressed from being too short or too long (and particularly at the ends thereof), thereby contributing to reduced size and thinner shape of the electrochemical device while also enabling the occurrence of short circuiting to be more adequately suppressed by preventing shifting of the electrodes and separator. In addition, the force that attempts to return the folded separator to its original shape can be reduced, which also prevents shifting of the electrodes and separator in the electrochemical device and enables the occurrence of short circuiting to be more adequately suppressed. Moreover, as a result of severed portions being arranged in the folds, there is the advantage of facilitating the movement of electrolyte solution through the severed portions.

In addition, in the electrochemical device of the present invention, the separator is preferably a separator composed of a non-woven fabric.

As a result, bending at the folds becomes easier, thereby enabling the separator to be folded accurately for each predetermined interval. Consequently, the separator is suppressed from being too short or too long (and particularly at the ends thereof), thereby contributing to reduced size and thinner shape of the electrochemical device while also enabling the occurrence of short circuiting to be more adequately suppressed by preventing shifting of the electrodes and separator. In addition, creases are more easily formed in a separator composed of a non-woven fabric, thereby enabling the force that attempts to return the bent separator to its original shape to be reduced, which also prevents shifting of the electrodes and separator in the electrochemical device and enables the occurrence of short circuiting to be more adequately suppressed.

In addition, in the electrochemical device of the present invention, an adhesive layer is preferably formed in the separator on the surface in the opposite direction from the bending direction of the folds.

As a result of forming this adhesive layer, an electrode in contact with the adhesive layer is fixed to the separator and prevented from shifting, thereby more adequately suppressing the occurrence of short circuiting in the electrochemical device. In an electrochemical device of the present invention having a separator of the shape described above in particular, since three electrodes in proximity to the first anode or first cathode surrounded by the separator can be arranged so as to contact the adhesive layer, the shifting of four proximal electrodes, including electrodes surrounded by the separator, can be adequately prevented, thereby enabling the occurrence of short circuiting in the electrochemical device to be more adequately suppressed. Furthermore, in the case of the number of electrodes in the electrochemical device is four, superior short circuiting preventive effects can be obtained since the shifting of all electrodes is prevented.

The present invention also provides a production method for an electrochemical device provided with a first anode, a first cathode, a single continuous separator provided between the first anode and the first cathode and folded so as to be arranged on an opposite side of the first anode to the first cathode and on an opposite side of the first cathode to the first anode, and an electrolyte in contact with the separator, the first anode and the first cathode, the separator having a shape that surrounds the periphery of the first anode or the first cathode by being folded in the same direction at two folds consecutive from one end of the separator, the method comprising: a first arrangement step, in which one of either the first anode or the first cathode is arranged on a surface between the two folds in the separator, a first folding step, in which the separator is folded at one of the folds and the folded separator is arranged on the first anode or first cathode arranged in the first arrangement step, a second arrangement step, in which the other first anode or first cathode is arranged on the folded separator, and a second folding step, in which the separator is folded at the other fold and the folded separator is arranged on the first anode or first cathode arranged in the second arrangement step.

According to this production method for an electrochemical device, the electrochemical device of the present invention as described above can be produced efficiently. In addition, according to this production method for an electrochemical device, workability can be improved and the occurrence of shifting of the electrodes and separator during production can be adequately prevented in comparison with the case of zigzag folding the separator.

More specifically, since it is necessary to fold the separator after placing electrodes on the ends of the separator in the case of zigzag folding the separator, the electrodes are susceptible to shifting in the production process, particularly at the ends of the separator, thereby resulting in increased likelihood of the occurrence of short circuiting. In addition, since force acts in the direction that returns the previously bent fold to its original shape during folding in the case of alternately folding the separator in opposite directions at the folds, it becomes difficult to form creases at the folds throughout the entire separator, thereby enabling force that returns the separator to its original shape to easily act in the direction of lamination. Consequently, shifting of the electrodes and separator occurs easily during the course of production while also resulting in inferior workability in the case of sealing a laminate of the electrodes and separator in a package.

In contrast, in the case of folding the separator in the same direction at two folds as in the present invention, since an electrode is placed between the two folds and the separator is folded so as to surround the electrode, this electrode is resistant to shifting during the course of production, thereby making it difficult for short circuiting to occur. In addition, in the case of folding the separator in the same direction at the two folds, since force acts in the same direction as the direction of the previous folding when folding the separator at the other fold after having folded at one of the folds, creases are easily formed more rigidly, thereby making it difficult for force that returns the separator to its original shape to act in the direction of lamination. Consequently, the occurrence of shifting of the electrodes and separator during the course of production is adequately prevented, and workability is superior even in the case of sealing a laminate of the electrodes and separator in a package.

In addition, in the production method for an electrochemical device of the present invention, the electrochemical device is preferably provided with a second cathode arranged on the outer peripheral surface of the separator so as to oppose the first anode with the separator interposed therebetween, and/or a second anode arranged on the outer peripheral surface of the separator so as to oppose the first cathode with the separator interposed therebetween, the method further comprising a connection step in which the first anode and the second anode and/or the first cathode and the second cathode are partially connected so that the mutual positional relationship thereof is fixed, prior to the first arrangement step.

In addition, in the production method for an electrochemical device of the present invention, the electrochemical device is provided with two or more of the first anode and/or the first cathode, and the production method preferably has a connection step in which the corresponding first anodes and/or the corresponding first cathodes are partially connected so that the mutual positional relationships thereof are fixed, prior to the first arrangement step.

As a result of preliminarily and respectively connecting anodes and cathodes in this manner, shifting of the electrodes during the course of production can be more adequately prevented, thereby enabling the occurrence of short circuiting to be more adequately suppressed.

In addition, in the production method for an electrochemical device of the present invention, severed portions and non-severed portions are preferably arranged in the folds of the separator, along said folds.

As a result, in addition to it being easy to fold the separator at the folds in the first and second folding steps, thereby resulting in dramatic improvement in work efficiency, the separator can also be folded accurately for each predetermined interval. Consequently, the separator is suppressed from being too short or too long (and particularly at the ends thereof), thereby contributing to reduced size and thinner shape of the electrochemical device while also enabling the occurrence of short circuiting to be more adequately suppressed by preventing shifting of the electrodes and separator during the course of production. In addition, the force that attempts to return the folded separator to its original shape can be reduced, which also prevents shifting of the electrodes and separator during the course of production and enables the occurrence of short circuiting to be more adequately suppressed.

In addition, the production method for an electrochemical device of the present invention preferably has a crease forming step prior to the first arrangement step in which the separator is folded in advance at the folds to form creases in the folds.

As a result of preliminarily forming creases in the folds, folding of the separator at the folds becomes easier in the first and second folding steps, thereby resulting in dramatic improvement in work efficiency, while also enabling the separator to be folded accurately for each predetermined interval. Consequently, the separator is suppressed from being too short or too long (and particularly at the ends thereof), thereby contributing to reduced size and thinner shape of the electrochemical device while also enabling the occurrence of short circuiting to be more adequately suppressed by preventing shifting of the electrodes and separator during the course of production. In addition, the force that attempts to return the folded separator to its original shape can be reduced, which also prevents shifting of the electrodes and separator during the course of production and enables the occurrence of short circuiting to be more adequately suppressed.

In addition, in the production method for an electrochemical device of the present invention, the separator is preferably a separator composed of a non-woven fabric.

Since a non-woven separator allows creases to be formed easily, as a result of using such a separator, the separator can be folded easily at the folds in the first and second folding steps, thereby resulting in a dramatic improvement in work efficiency. In addition, since creases can be formed easily, the force that attempts to return the folded separator to its original shape can be reduced, thereby preventing shifting of the electrodes and separator during the course of production and enabling the occurrence of short circuiting to be more adequately suppressed.

In addition, in the production method for an electrochemical device of the present invention, an adhesive layer is preferably formed in the separator on the surface in the opposite direction from the direction in which the separator is folded at the folds.

As a result of forming this adhesive layer in the separator, electrodes in contact with the adhesive layer are fixed to the separator and prevented from shifting during the course of production, thereby more adequately suppressing the occurrence of short circuiting. In the production method for an electrochemical device of the present invention having a separator of the shape described above in particular, since three electrodes in proximity to the first anode or first cathode surrounded by the separator can be arranged so as to contact the adhesive layer, the shifting of four proximal electrodes, including electrodes surrounded by the separator, can be adequately prevented, thereby enabling the occurrence of short circuiting to be more adequately suppressed. Furthermore, in the case of the number of electrodes in the electrochemical device is four, superior short circuiting preventive effects can be obtained since the shifting of all electrodes is prevented during the course of production.

Moreover, the present invention provides a production method for an electrochemical device provided with a first anode, a first cathode, a single continuous separator provided between the first anode and the first cathode and folded so as to be arranged on the opposite side of the first anode to the first cathode and on the opposite side of the first cathode to the first anode, and an electrolyte in contact with the separator, the first anode and the first cathode; wherein the separator has a shape that surrounds the periphery of the first anode or the first cathode by being folded in the same direction at two folds consecutive from one end of the separator, and the electrochemical device is provided with a second cathode arranged on the outer peripheral surface of the separator so as to oppose the first anode with the separator interposed therebetween, and/or a second anode arranged on the outer peripheral surface of the separator so as to oppose the first cathode with the separator interposed therebetween; comprising: an adhesive layer formation step, in which an adhesive layer is formed on one of the surfaces of the separator, a mounting step, in which a first electrode, a second electrode and a third electrode are mounted on the adhesive layer in that order from one edge of the separator such that the folds are interposed between each electrode, an arrangement step, in which a fourth electrode is arranged on the surface of the separator opposite from the surface having the adhesive layer interposed between the two folds, and a folding step, in which a structure is formed in which the second and fourth electrodes and then the first and third electrodes are laminated in that order while at least interposing the separator between each electrode by folding the separator at one of the folds near the end thereof followed by folding at the other fold to surround the periphery of the fourth electrode; wherein the first electrode is the first anode or the first cathode, the second electrode is either the second anode or the second cathode and is of the same polarity as the first electrode, the third electrode is one of the first anode, the second anode, the first cathode and the second cathode, and the fourth electrode is either the first anode or the first cathode and has opposite polarity from the first electrode.

According to this production method for an electrochemical device, an electrochemical device of the present invention can be efficiently produced in which an adhesive layer is formed on the surface of a separator in the opposite direction from the direction in which the separator is folded at the folds. In addition, according to this production method for an electrochemical device, workability can be improved and the occurrence of shifting of the electrodes and separator during production can be adequately prevented as compared with the case of zigzag folding the separator.

Namely, in the case of folding the separator in the same direction at the locations of two folds as in the present invention, since an electrode can be placed between the two folds and the separator can be folded so as to surround the electrode, it is difficult for the electrode to shift during the course of production thereby making it difficult for short circuit defects to occur. In addition, in the case of folding the separator in the same direction at the two folds, since it is difficult for force to act in the same direction as the direction in which the separator has previously been folded at one fold when folded at the other fold after having been folded at one of the folds, creases are formed more rigidly thereby making it difficult for force that returns the separator to its original shape to act. Consequently, the occurrence of shifting of the electrodes and separator during the course of production is adequately prevented, thereby resulting in superior workability in the case of sealing a laminate of the electrodes and separator in a package.

In addition, in the production method for an electrochemical device as described above, since an adhesive layer is formed on a surface of the separator in the opposite direction from the direction in which the separator is folded at the folds, and first to third electrodes are mounted on this adhesive layer, first to fourth proximal electrodes, including a fourth electrode surrounded by the separator, can be adequately prevented from shifting, thereby making it possible to adequately suppress the occurrence of short circuiting. In addition, since the adhesive layer is only required to be formed on one surface of the separator, work efficiency is also superior. Furthermore, in the case the number of electrodes in the electrochemical device is four, superior short circuiting preventive effects can be obtained since shifting of all electrodes is prevented during the course of production.

According to the present invention, an electrochemical device resistant to the occurrence of short circuiting, and a production method thereof, can be provided.

### BRIEF DESCRIPTION OF THE DRAWINGS

FIG. 1 is a front view showing a preferred embodiment of an electrochemical device of the present invention in the form of a lithium ion secondary battery;

FIG. 2 is a developed view showing the inside of the lithium ion secondary battery shown in FIG. 1;

FIG. 3 is a schematic cross-sectional view showing the positional relationship between electrodes and separator in an electrochemical device of the present invention;

FIG. 4 is a schematic cross-sectional view showing another example of the positional relationship between electrodes and separator in an electrochemical device of the present invention;

FIG. 5 is a schematic cross-sectional view showing another example of the positional relationship between electrodes and separator in an electrochemical device of the present invention;

FIG. 6 is a schematic cross-sectional view showing another example of the positional relationship between electrodes and separator in an electrochemical device of the present invention;

FIG. 7 is a schematic cross-sectional view showing another example of the positional relationship between electrodes and separator in an electrochemical device of the present invention;

FIG. 8 is a schematic cross-sectional view showing the positional relationship between electrodes and separator in an electrochemical device of the prior art;

FIG. 9 is a schematic cross-sectional view showing the positional relationship between electrodes and separator in an electrochemical device of the prior art;

FIG. 10 is a cross-sectional view taken along line II-II of the lithium ion secondary battery shown in FIG. 1;

FIG. 11 is a developed view showing another example of the inside of a lithium ion secondary battery;

FIG. 12 is a developed view showing another example of the inside of a lithium ion secondary battery; and

(a) to (f) of FIG. 13 constitute a flow chart showing a production method of a laminate in an electrochemical device of the present invention.

### DESCRIPTION OF THE PREFERRED EMBODIMENTS

The following provides a detailed explanation of preferred embodiments of the present invention with reference to the drawings. Furthermore, in the drawings, the same reference symbols are used to indicate the same or equivalent components, and duplicative explanations are omitted. Positional relationships such as up, down, left and right are based on the positional relationships shown in the drawings unless specifically indicated otherwise. Moreover, the dimensional ratios in the drawings are not limited to the ratios shown in the drawings.

(Electrochemical Device)

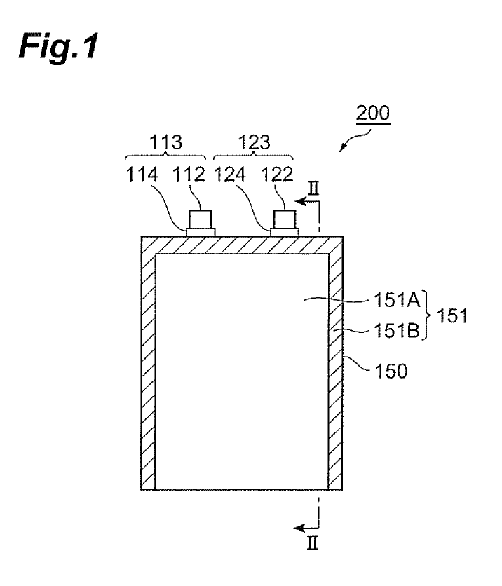

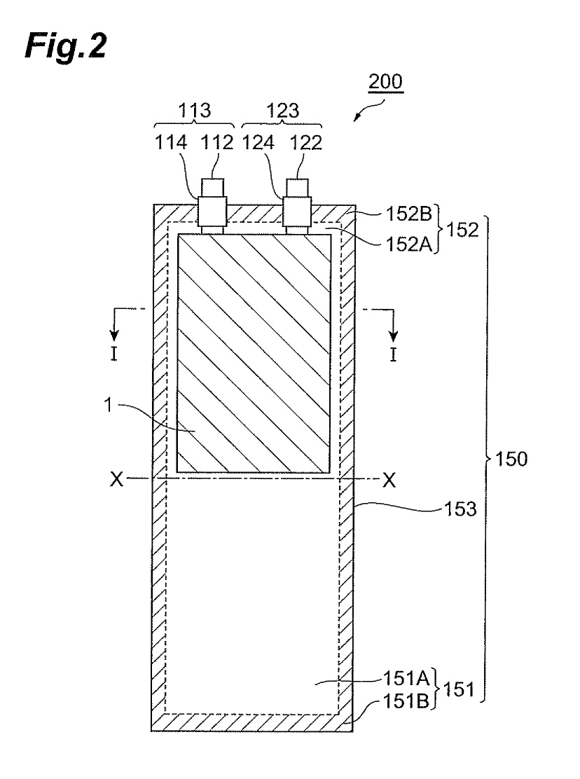

FIG. 1 is a front view of a preferred embodiment of an electrochemical device of the present invention in the form of a lithium ion secondary battery. In addition, FIG. 2 is a developed view showing the inside of the lithium ion secondary battery shown in FIG. 1.

As shown in FIGS. 1 and 2, a lithium ion secondary battery 200 is mainly provided with a laminate 1, comprised of an anode, a cathode and a separator, an electrolyte solution (not shown) impregnated into the laminate 1, and a case 150 that houses these components in a sealed state. In addition, the lithium ion secondary battery 200 is provided with an anode lead 112, of which one end is electrically connected to the anode of laminate 1 while the other end protrudes outside the case 150, and a cathode lead 122, of which one end is electrically connected to the cathode while the other end protrudes outside the case 150.

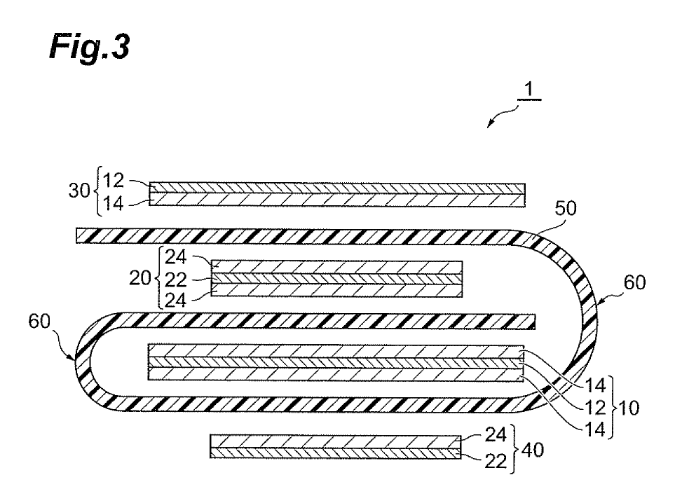

FIG. 3 is a cross-sectional view taken along line I-I of the laminate 1 shown in FIG. 2 showing the positional relationship between the anode, cathode and separator in the present invention. As shown in FIG. 3, the laminate 1 is provided with a first anode 10, a first cathode 20, and a single, continuous separator 50 folded so as to be arranged between the first anode 10 and the first cathode 20 on the side of the first anode 10 opposite from the first cathode 20 and on the side of the first cathode 20 opposite from the first anode 10. The separator 50 has a shape that surrounds the periphery of the first anode 10 by being folded in the same direction at two consecutive folds 60 formed for each predetermined interval from at least one end of the separator 50. Moreover, a second cathode 40 opposing the first anode 10 with the separator 50 interposed between, and a second anode 30 opposing the first cathode 20 with the separator 50 interposed between, are provided on the outer peripheral surface of the separator 50. Furthermore, although a gap is present between each electrode and the separator in FIG. 3, in actuality, the electrodes and the separator are adhered.

As a result of the separator 50 having the shape as shown in FIG. 3, the periphery of the first anode 10 is surrounded by the separator 50, thereby adequately preventing the occurrence of shifting of the first anode 10 in the horizontal direction of FIG. 3. Consequently, the occurrence of short circuiting between the first anode 10 and an electrode in opposition thereto with the separator 50 interposed there between, namely the first cathode 20 and the second cathode 40, is adequately suppressed. In addition, although a problem in the form of a change in the performance of the electrochemical device occurs in the case the opposing surface areas of opposing electrodes change as a result of the electrodes having shifted position, in the laminate 1 as described above, since shifting of the first anode 10 is adequately prevented, stable performance can be obtained.

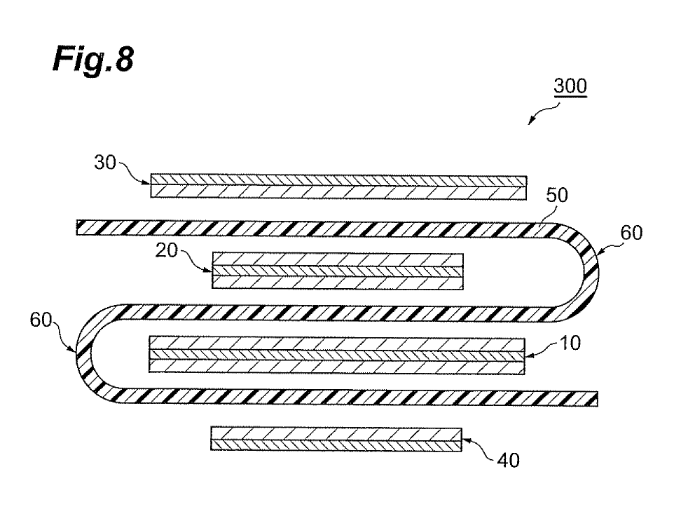

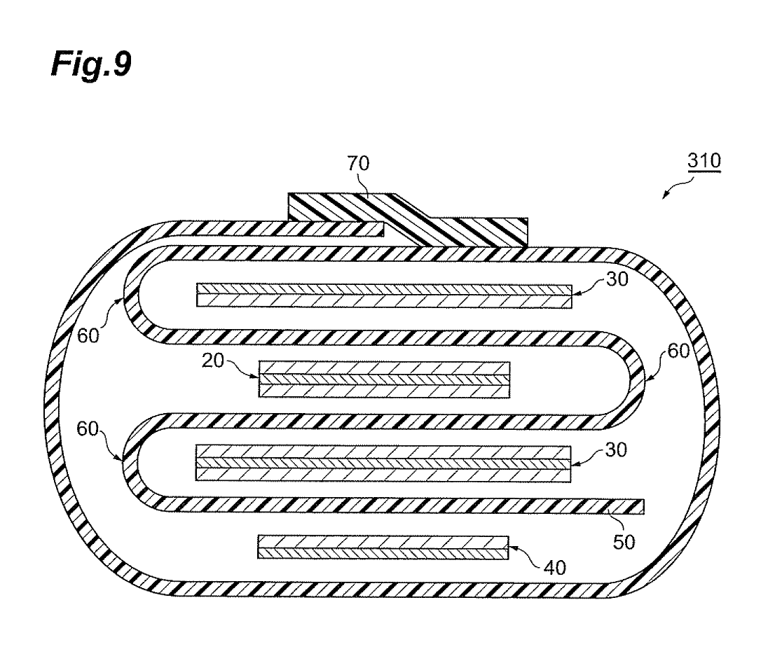

Furthermore, FIGS. 8 and 9 are schematic cross-sectional views showing the positional relationships of a conventional anode, cathode and separator in the case of having folded the separator 50 into a zigzag shape. In a conventional laminate 300 shown in FIG. 8, the separator 50 has a zigzag shape in which it is alternately folded in opposite directions. Consequently, both electrodes easily shift in the horizontal direction of FIG. 8 thereby resulting in increased susceptibility to short circuiting between the electrodes and fluctuations in performance of the electrochemical device. In a conventional laminate 310 shown in FIG. 9, after having formed the separator 50 in a zigzag shape by alternately folding in opposite directions, the separator 50 is arranged so as to cover the entire laminate, with the end thereof being fixed in position with a fastening tape 70. In this case, since the entire laminate is covered with the separator 50 and the fastening tape 70 is used, the thickness in these areas increases, making this disadvantageous for reducing size and thickness. Furthermore, in the case of the laminate 310 shown in FIG. 9, work efficiency during production is particularly poor and shifting of the electrodes and separator occurs easily during the course of production. These problems of the prior art can be improved by employing the structure of the above-mentioned laminate 1 of the present invention.

The following provides an explanation of each constituent feature of the laminate 1 and lithium ion secondary battery 200 in the present invention.

As shown in FIG. 3, the first anode 10 and the second anode 30 are composed of a current collector 12 and a anode active material-containing layer 14 formed on the current collector 12, and the anode active material-containing layer 14 is formed on both side of the current collector 12 in the first anode 10 and on one side of the current collector 12 in the second anode 30. In addition, the first cathode 20 and the second cathode 40 are composed of a current collector 22 and a cathode active material-containing layer 24 formed on the current collector 22, and the cathode active material-containing layer 24 is formed on both sides of the current collector 22 in the first cathode 20 and on one side of the current collector 22 in the second cathode 40.

There are no particular limitations on the current collector 12 and the current collector 22 provided they are good conductors able to adequately transfer charge to the anode active material-containing layer 14 and the cathode active material-containing layer 24, and known current collectors used in lithium ion secondary batteries can be used. For example, examples of the current collectors 12 and 22 include metal foils each made of copper, aluminum and the like.

The anode active material-containing layer 14 is a layer containing an anode active material, a conductive auxiliary agent, a binder and the like.

There are no particular limitations on the anode active material provided it allows occlusion and discharge of lithium ions, elimination and insertion of lithium ions, or doping and dedoping of lithium ions and counter anions of said lithium ions (such as ClO₄⁻) to proceed reversibly, and known materials similar to those used in lithium ion secondary batteries can be used. Examples of such active materials include carbon materials such as natural graphite, artificial graphite, meso carbon microbeads, meso carbon fibers (MCF), cokes, glass-like carbon and calcined organic compounds, metals capable of compounding with lithium such as Al, Si or Sn, amorphous compounds consisting mainly of oxides such as SiO₂ or SnO₂, and lithium titanium oxide (Li₄Ti₅O₁₂).

In addition, the thickness of the anode active material-containing layer 14 is preferably 15 to 80 μm. In addition, the loaded amount of anode active material in the anode active material-containing layer 14 is preferably 2 to 12 mg/cm². Here, the loaded amount refers to the mass of anode active material per unit surface area of the anode current collector 12.

There are no particular limitations on the conductive auxiliary agent provided it improves the electrical conductivity of the anode active material-containing layer 14, and known conductive auxiliary agents can be used, examples of which include carbon blacks, carbon materials, metal powders such as those of copper, nickel, stainless steel or iron, mixtures of carbon materials and metal powders, and conductive oxides such as ITO.

There are no particular limitations on the binder provided it is able to bind particles of the anode active material and particles of the conductive auxiliary agent to the anode current collector 12, and known binders can be used, examples of which include fluororesins such as polyvinylidene fluoride (PVDF), polytetrafluoroethylene (PTFE), tetrafluoroethylene-hexafluoropropylene copolymer (FEP), tetrafluoroethylene-perfluoroalkyl vinyl ether copolymer (PEA), ethylene-tetrafluoroethylene copolymer (ETFE), polychlorotrifluoroethylene (PCTFE), ethylene-chlorotrifluoroethylene copolymer (ECTFE) and polyvinyl fluoride (PVF), as well as styrene-butadiene rubber (SBR).

The cathode active material-containing layer 24 is a layer containing a cathode active material, conductive auxiliary agent, binder and the like.

There are no particular limitations on the cathode active material provided it allows occlusion and discharge of lithium ions, elimination and insertion (intercalation) of lithium ions, or doping and dedoping of lithium ions and counter anions of said lithium ions (such as ClO₄⁻) to proceed reversibly, and known electrode active materials can be used, examples of which include lithium cobalt oxide (LiCoO₂), lithium nickel dioxide (LiNiO₂), lithium manganese spinel (LiMn₂O₄) and composite metal oxides represented by the general formula: LiNiₓCo_{y}Mn_{z}O₂ (wherein, x+y+z=1) as well as compound metal oxides such as lithium vanadium compounds (LiV₂O₅), olivine type LiMPO₄ (wherein, M represents Co, Ni, Mn or Fe) or lithium titanium oxide (Li₄Ti₅O₁₂).

The thickness of the cathode active material-containing layer 24 is preferably 15 to 90 μm. In addition, although the loaded amount of the cathode active material in the cathode active material-containing layer 24 can be arbitrarily and preferably set corresponding to the loaded amount of the anode active material of the anode active material-containing layer 14, it is preferably, for example, 5 to 25 mg/cm².

The same substances as those that compose the anode active material-containing layer 14 can be used for each of the constituent features contained in the cathode active material-containing layer 24 other than the cathode active material. In addition, a conductive auxiliary agent similar to that in the anode active material-containing layer 14 is preferably also contained in the cathode active material-containing layer 24.

The separator 50 is formed from an electrically insulating porous body. There are no particular limitations on the material of the separator 50, and a known separator material can be used. Examples of electrically insulating porous bodies include laminates of films composed of polyacrylonitrile, polyethylene, polypropylene or polyolefin, stretched films of mixtures of the above-mentioned resins, and fibrous non-woven fabrics composed of at least one type of composite material selected from the group consisting of cellulose, polyester and polypropylene.

Although the separator 50 is folded at two consecutive folds 60 formed for each predetermined interval from one end thereof, a severed portion and a non-severed portion are preferably arranged along the folds 60 in the folds 60. That in which the severed and non-severed portions are arranged may be any such portions provided they facilitate bending of the folds 60, examples of which include perforations in which a plurality of severed and non-severed portions are alternately arranged, and portions in which only both ends of the folds 60 are cut out.

In addition, in the separator 50 shown in FIG. 3, the interval to the first fold 60 from one end thereof, the interval to the second fold 60 from the first fold 60, and the interval from the second fold 60 to the other end of the separator 50 are made to be roughly equal predetermined intervals. However, these three intervals may not be completely identical, but rather may be respectively different intervals corresponding to the locations where the folded portion of the separator 50 are arranged, namely the thicknesses of the interposing electrodes and the separator.

In addition, an adhesive layer may be formed on the separator 50 on the surface on the side in the opposite direction from the direction of bending of the folds 60, namely on the surface in contact with the second anode 30, the first cathode 20 and the second cathode 40 in FIG. 3.

This adhesive layer is preferably partially formed on one surface of the separator 50 so that each electrode is fixed to the separator 50. For example, in the case only the center of each electrode is fixed to the separator 50 by means of the adhesive layer, electrolyte solution is able to easily penetrate between each electrode and the separator 50 after fixing. Thus, after each electrode and the separator 50 have been fixed, electrolyte solution is able to impregnate the active-material containing layer of each electrode and the separator 50.

Furthermore, in the case of fixing each electrode to the separator 50 with the adhesive layer interposed there between, since there is the risk of the adhesive inhibiting diffusion of lithium ions or inhibiting the permeation of electrolyte solution, the number of locations where the adhesive layer is formed (number of locations where the adhesive is applied) is preferably as few as possible, and the surface area over which the adhesive layer is formed is preferably as narrow as possible. More specifically, the locations where the adhesive is applied preferably consist of only one point in the center of the surface where the adhesive it to be applied of the separator 50 and each electrode. In addition, although the ratio of the surface area over which the adhesive is applied to the total applicable surface is suitably determined corresponding to the type of adhesive, surface area of the total applicable surface and so forth so as to obtain a degree of adhesive strength that does not allow shifting, normally this ratio is preferably selected from within the range of 0.001 to 1% of the applicable surface of each electrode.

The adhesive used in the adhesive layer is preferably a hot melt adhesive. Hot melt adhesives can be used without any particular limitations provided they are able to adhere the electrodes and separator 50 while also having a melting point lower than the polymer serving as a constituent component of the electrodes and separator 50. Examples of such hot melt adhesives that can be used include ethylene-methacrylic acid copolymers.

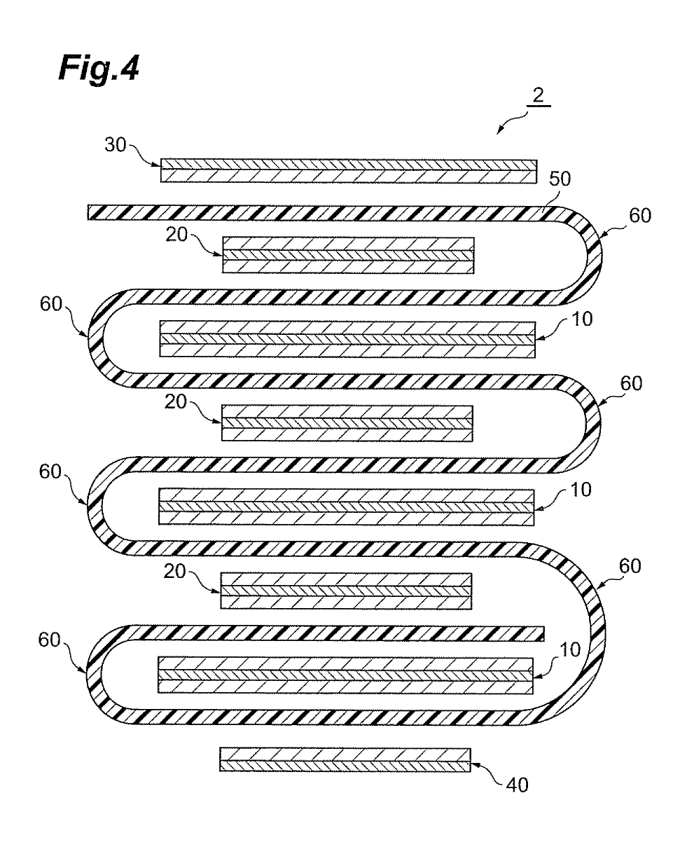

The following provides an explanation of other examples of the structure of the laminate in the present invention. FIGS. 4 to 7 are schematic cross-sectional view showing other forms of laminates in the present invention.

A laminate 2 shown in FIG. 4 has a structure in which three first anodes 10 and three first cathodes 20 are laminated, with the second anode 30 and the second cathode 40 being arranged on the outer periphery surface of the separator 50. The separator 50 has a shape that surrounds one first anode 10 by being folded at two consecutive folds 60 in the same direction at one end thereof, and is folded in mutually opposite directions at subsequent folds 60.

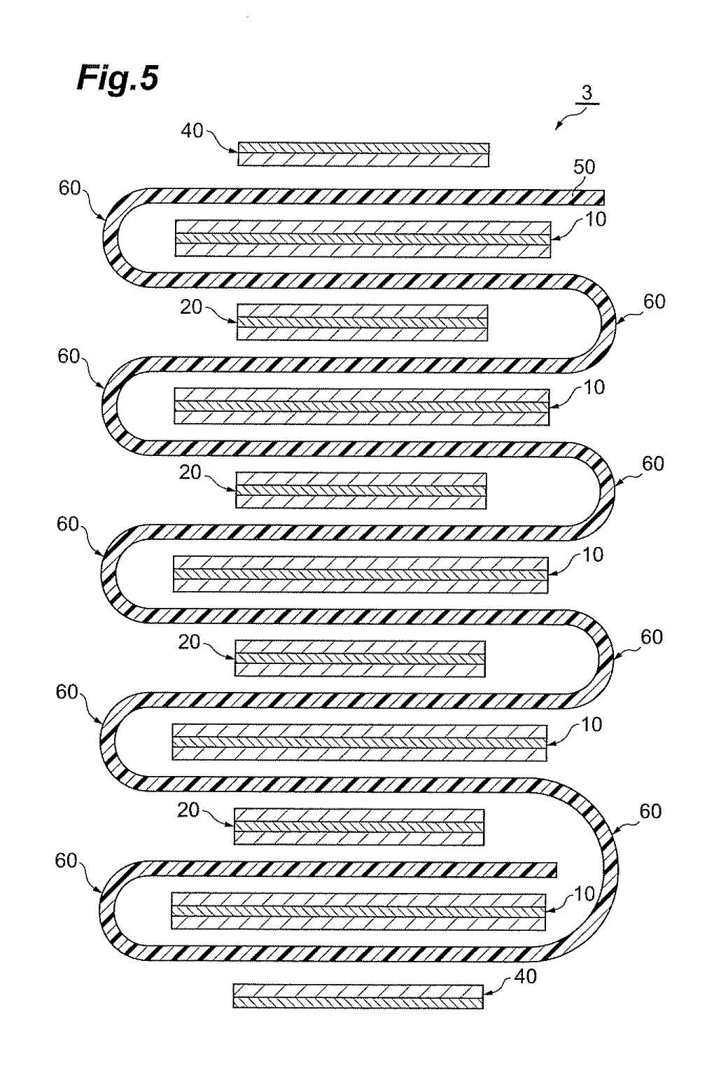

A laminate 3 shown in FIG. 5 has a structure in which five first anodes 10 and four first cathodes 20 are laminated, with two second cathodes 40 being arranged on the outer peripheral surface of the separator 50. The separator 50 has a shape that surrounds one first anode 10 by being folded at two consecutive folds 60 at one end thereof, and is folded in mutually opposite directions at subsequent folds 60.

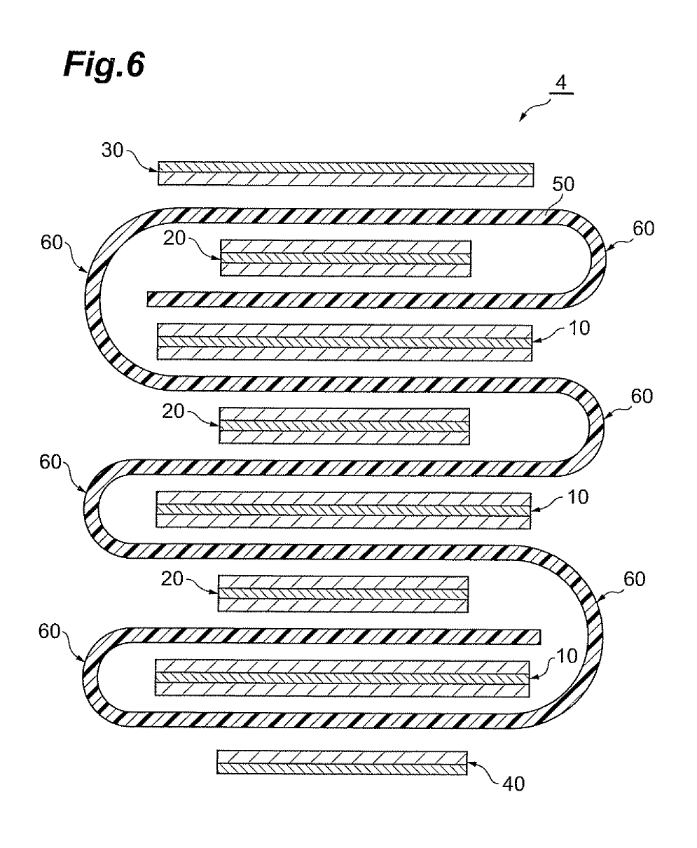

A laminate 4 shown in FIG. 6 has a structure in which three first anodes 10 and three first cathodes 20 are laminated, with the second anode 30 and the second cathode 40 being arranged on the outer peripheral surface of the separator 50. The separator 50 has a shape that respectively surrounds one first anode 10 at one end and one first cathode 20 at the other end by being folded at two consecutive folds 60 in the same direction at both ends thereof and being folded in mutually opposite directions at folds 60 there between.

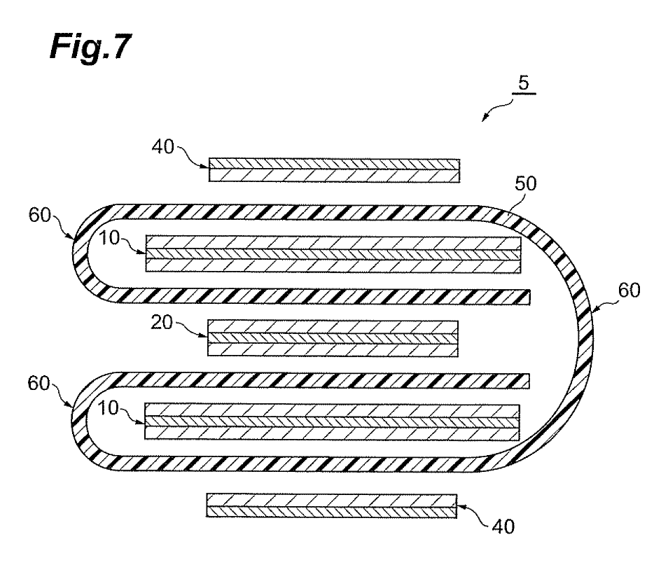

A laminate 5 shown in FIG. 7 has a structure in which two first anodes 10 and one first cathode 20 are laminated, with two second cathodes 40 arranged on the outer peripheral surface of the separator 50. The separator 50 has a shape that respectively surrounds one first anode 10 at one end and one first anode 10 at the other end as well by being folded at two consecutive folds 60 in the same direction at both ends thereof.

Since each of the laminates shown in FIGS. 4 to 7 have a structure in which a first anode or a first cathode is surrounded by the separator at least one end of the separator, shifting of the surrounded electrode is prevented, thereby adequately suppressing the occurrence of short circuiting. In particular, since the laminates shown in FIGS. 6 and 7 have a shape in which both ends of the separator surround a first anode or a first cathode, the occurrence of short circuiting is more adequately suppressed.

Furthermore, the locations of the anodes and cathodes may be interchanged in the laminates shown in FIGS. 3 to 7.

An electrolyte solution is contained within the pores of the anode active material-containing layer 14, the cathode active material-containing layer 24 and the separator 50. There are no particular limitations on the electrolyte solution, and a known electrolyte solution used in lithium ion secondary batteries is used. An electrolyte solution containing a lithium salt (aqueous electrolyte solution or electrolyte solution using an organic solvent) can be used. However, since the withstand voltage during charging is held to a low level in the case of aqueous electrolyte solutions due the low electrochemical decomposition voltage, the electrolyte solution is preferably an electrolyte solution that uses an organic solvent (non-aqueous electrolyte solution). An electrolyte solution in which a lithium salt is dissolved in a non-aqueous solvent (organic solvent) is used preferably for the electrolyte solution of a secondary battery. Examples of lithium salts used include LiPF₆, LiClO₄, LiBF₄, LiAsF₆, LiCF₃SO₃, LiCF₃, CF₂SO₃, LiC(CF₃SO₂)₃, LiN(CF₃SO₂)₂, LiN(CF₃CF₂SO₂)₂, LiN(CF₃SO₂)(C₄F₉SO₂) and LiN(CF₃CF₂CO)₂. Furthermore, one type of these salts may be used alone or two or more types may be used in combination.

In addition, a known solvent used in secondary batteries can be used for the organic solvent, preferable examples of which include propylene carbonate, ethylene carbonate and diethyl carbonate. These may be used alone or two or more types may be mixed in an arbitrary ratio.

Furthermore, in the present invention, the electrolyte solution may be in the form of a gelatinous electrolyte obtained by adding a gelling agent in place of a liquid electrolyte. In addition, a solid electrolyte (electrolyte composed of a solid polymer electrolyte or ion-conducting inorganic material) may be used instead of an electrolyte solution.

There are no particular limitations on the case 150 provided it conceals the laminate 1 and is able to prevent the entrance of air and water into the case, and a known case used in secondary batteries can be used. For example, a case made of a synthetic resin such as epoxy resin or a metal sheet such as an aluminum sheet laminated with a resin can be used.

The case 150 is formed using a pair of mutually opposing films (first film 151 and second film 152). Here, as shown in FIG. 2, the first film 151 and the second film 152 are connected in the present embodiment. Namely, in the present embodiment, the case 150 is formed by bending a rectangular film composed of a single composite packaging film along bending line X-X shown in FIG. 2, and then overlapping one set of opposing edges of the rectangular film (edge 151B of the first film 151 and edge 152B of the second film 152 in the drawing) followed by using an adhesive or carrying out heat-sealing. Furthermore, reference symbol 151A in FIGS. 1 and 2 and reference symbol 152A in FIG. 2 indicate those regions of the first film 151 and the second film 152, respectively, that are not adhered or heat-sealed.

The first film 151 and the second film 152 respectively indicate the portions of the film having mutually opposing surfaces formed when bending the single rectangular film in the manner described above. Here, in the present description, the respective edges of the first film 151 and the second film 152 after being joined are referred to as “sealed portions.”

As a result, since it is no longer necessary to provide a sealed portion for joining the first film 151 and the second film 152 at the portion of the bending line X-X, the sealed portion of the case 150 can be reduced. As a result, the volume energy density of the lithium ion secondary battery 200 based on the volume of the space where it is to be installed can be further improved.

As shown in FIGS. 1 and 2, an external terminal 113 and an external terminal 123 extend outside the case 150 from within the case 150 by intersecting the sealed portion. The external terminal 113 and external terminal 123 are separated in the direction perpendicular to the direction of lamination of the laminate 1.

The external terminal 113 is composed of a flat anode lead 112, and an insulator 114 that covers the portion surrounded by the sealed portion of the case 150, while the external terminal 123 is composed of a flat cathode lead 122 and an insulator 124 that covers the portion surrounded by the sealed portion of the case 150.

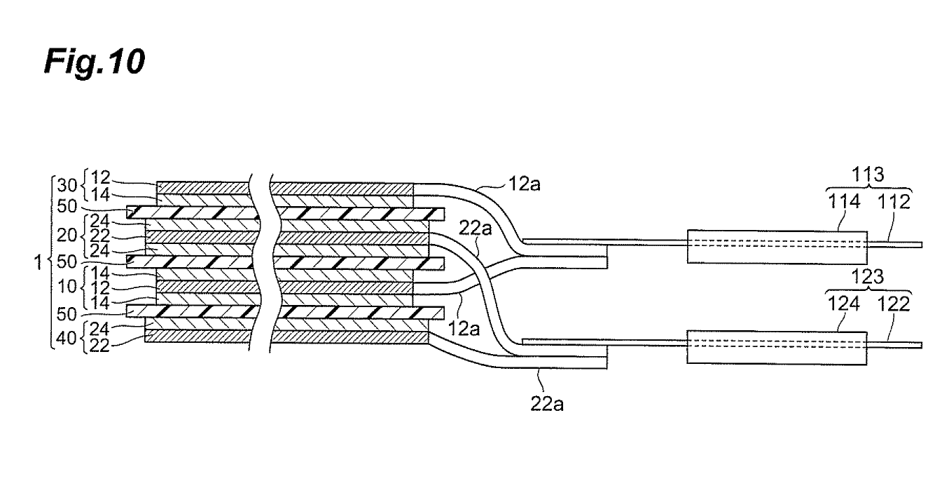

FIG. 10 is a cross-sectional view taken along line II-II of the lithium ion secondary battery 200 shown in FIG. 1. Furthermore, in FIG. 10, the positional relationship of the external terminal 113 and the external terminal 123 is altered and case 150 is omitted for the sake of convenience.

As shown in FIG. 10, a tongue 12a, extending towards the outside from each current collector, is formed on the end of each current collector 12 of the first anode 10 and the second anode 30. In addition, a tongue 22a, extending towards the outside from each current collector, is formed on the end of each current collector 22 of the first cathode 20 and the second cathode 40.

The end of the lead 112 within the case 150 is joined by resistance soldering and the like to each tongue 12a of each current collector 12 for the first anode 10 and the second anode 30 as shown in FIG. 10. Here, the lead 112 is formed from an electrically conductive material such as a metal. An electrically conductive material such as copper or nickel can be used for the electrically conductive material.

On the other hand, the end of the lead 122 within the case 150 is joined by resistance soldering and the like to each tongue 22a of each current collector 22 for the first cathode 20 and the second cathode 40. This lead 122 is also formed from an electrically conductive material such as a metal. A metal such as aluminum can be used for the electrically conductive material.

In addition, the insulator 114 and the insulator 124 enhance sealing between the leads 112 and 122 and the case 150. There are no particular limitations on the material of the insulators 114 and 124, and they are formed from, for example, a synthetic resin.

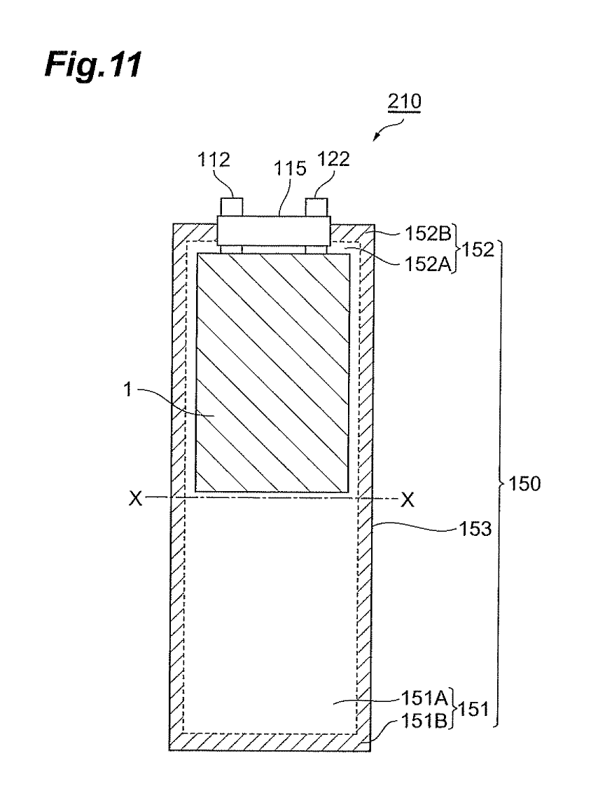

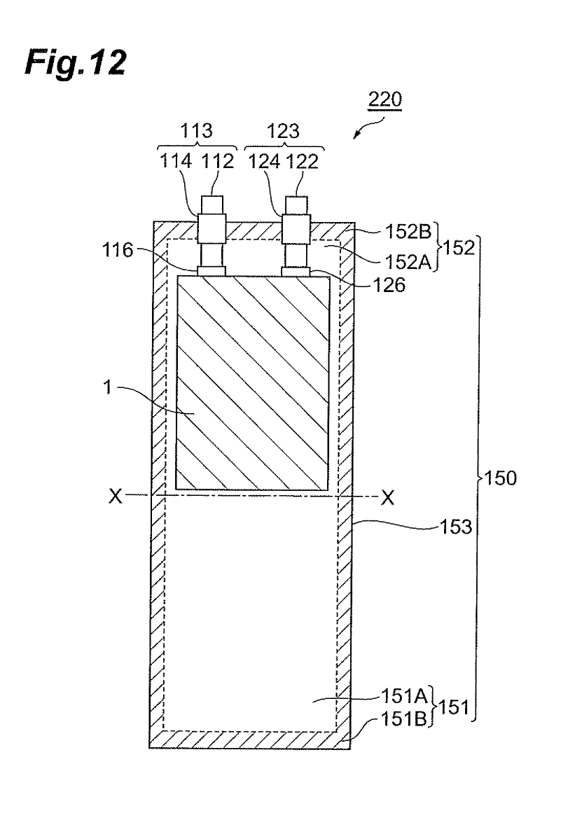

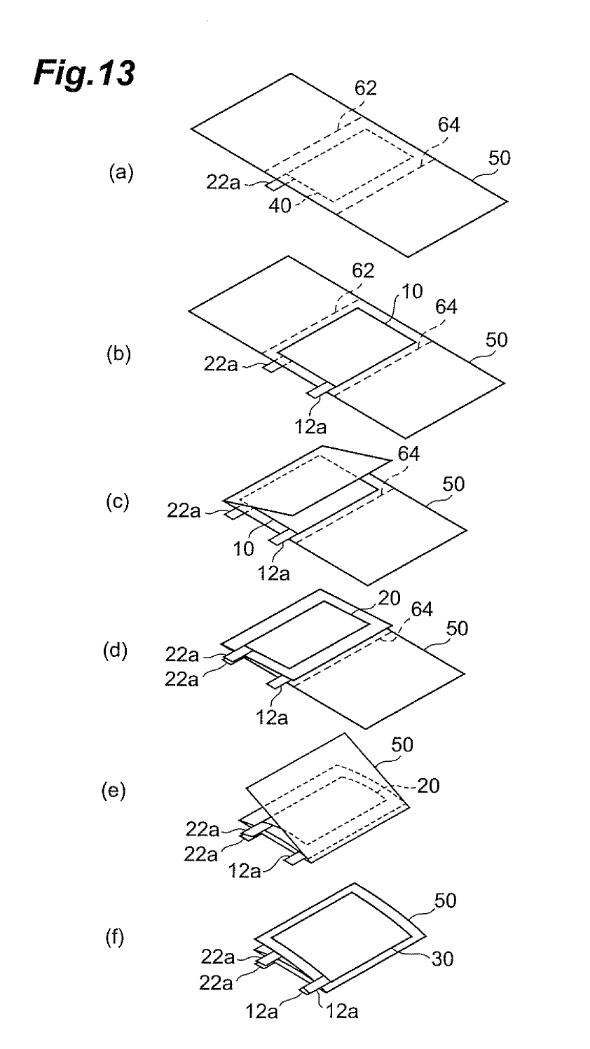

FIGS. 11 and 12 are developed views showing other examples of a lithium ion secondary battery. The anode lead 112 and the cathode lead 122 may be covered with a single insulator 115 at a portion between the sealed portions of the case 150 as in a lithium ion secondary battery 210 shown in FIG. 11. As a result of covering the anode lead 112 and the cathode lead 122 with a single insulator 115 in this manner, the mutual positional relationship thereof is adequately fixed, thereby making it possible to adequately prevent shifting of the electrodes.

In addition, the tongue 12a of each current collector 12 of the first anode 10 and the second anode 30 may be fixed with a fixing resin 116, and the tongue 22a of each current collector 22 of the first cathode 20 and the second cathode 40 may be fixed with a fixing resin 126 as in a lithium ion secondary battery 220 shown in FIG. 12. As a result of each current collector 12 of the first anode 10 and the second anode 30 being connected and fixed, and each current collector 22 of the first cathode 20 and the second cathode 40 being connected and fixed, the mutual positional relationships thereof are adequately fixed, thereby making it possible to adequately prevent shifting of the electrodes.

(Production Method for an Electrochemical Device)

The following provides an explanation of a production method for the lithium ion secondary battery 200 described above as an embodiment of the production method for an electrochemical device of the present invention.

First, a coating liquid (slurry) containing constituent materials for forming the anode active material-containing layer 14 of the first anode 10 and the second anode 30, and a coating liquid (slurry) containing constituent materials for forming the cathode active material-containing layer 24 of the first cathode 20 and the second cathode 40, are respectively prepared. The anode coating liquid contains the above-mentioned anode active material, conductive auxiliary agent, binder and the like, while the cathode coating liquid contains the above-mentioned cathode active material, conductive auxiliary agent, binder and the like. There are no particular limitations on the solvent used in the coating liquids provided it is able to dissolve the binder and disperse the active materials and conductive auxiliary agent, and examples of solvents that can be used include N-methyl-2-pyrrolidone and N,N-dimethylformamide.

Next, the anode current collector 12, formed from copper or nickel and the like, and the cathode current collector 22, formed from aluminum and the like, are respectively prepared. An anode coating liquid is then coated onto both sides of an anode current collector 12 and dried, followed by forming an anode active material-containing layer 14 on both sides thereof to obtain a first anode sheet. In addition, an anode coating liquid is coated onto one side of an anode current collector 12 and dried followed by forming an anode active material-containing layer 14 on one side thereof to obtain a second anode sheet. In addition, a cathode coating liquid is coated onto both sides of a cathode current collector 22 and dried followed by forming a cathode active material-containing layer 24 on both sides thereof to obtain a first cathode sheet. Moreover, a cathode coating liquid is coated onto one side of a cathode current collector 22 and dried followed by forming a cathode active material-containing layer 24 on one side thereof to obtain a second cathode sheet.

Here, there are no particular limitations on the method used when coating each of the coating liquids onto each of the current collectors, and the method may be suitably determined corresponding to the material, shape and so forth of the metal sheet used for the current collectors, examples of which include metal mask printing, electrostatic coating, dip coating, spray coating, roll coating, doctor blade coating, gravure coating and screen printing. Following coating, rolling treatment is carried out as necessary using a flat bed press or calendar roll.

Next, the resulting first and second anode sheets and first and second cathode sheets are respectively stamped out to a rectangular shape of a desired size to fabricate first anode 10, second anode 30, first cathode 20 and second cathode 40. Here, stamping is carried out so that tongues 12a and 22a are formed extending from the ends of the current collectors of each electrode. In addition, the anode active material-containing layer 14 and the cathode active material-containing layer 24 are not formed on both sides of the tongues 12a and 22a, but rather the current collectors are left exposed. Furthermore, the first anode 10 and the second anode 30 are preferably stamped to a rectangular shape that is larger than the rectangular shape of the first cathode 20 and the second cathode 40.

Continuing, a separator 50 is prepared composed of an insulating porous material. The separator 50 is preferably such that the size of the rectangle formed when folded three times by folding in the same direction at two consecutive folds 60 formed for each predetermined interval is larger than the size of the rectangular shape of the first anode 10 and the second anode 30.

In addition, perforations or notches and the like are preferably formed in the two folds 60 in the separator 50 by arranging severed portions and non-severed portions in advance. Moreover, the two folds 60 preferably have creases formed therein by being bent in advance.

Moreover, an adhesive layer as previously described may be formed in the separator 50 on the surfaces thereof in the opposite direction from the direction in which the folds 60 are bent, namely on the surfaces in contact with the second anode 30, the first cathode 20 and the second cathode 40 in FIG. 3.

Next, an explanation is provided of the procedure for forming the laminate 1 using each of the constituents described above. Here, (a) to (f) of FIG. 13 constitute a flow chart showing the procedure for the production method for the laminate 1 in the lithium ion secondary battery 200.

First, as shown in (a) of FIG. 13, the separator 50 is arranged on the second cathode 40. At this time, the second cathode 40 is arranged beneath the surface interposed between two folds (first fold 62 and second fold 64) in the separator 50.

Next, as shown in (b) of FIG. 13, the first anode 10 is arranged on the surface interposed between the first fold 62 and the second fold 64 in the separator 50 (first arrangement step).

Next, as shown in (c) of FIG. 13, the separator 50 is folded at the first fold 62, and the folded separator 50 is arranged on the first anode 10 (first folding step).

Next, as shown in (d) of FIG. 13, the first cathode 20 is arranged on the folded separator 50 (second arrangement step).

Next, as shown in (e) of FIG. 13, the separator 50 is folded at the second fold 64, and the folded separator 50 is arranged on the first cathode 30 (second folding step).

Finally, as shown in (f) of FIG. 13, the second anode 30 is arranged on the folded separator 50 to complete fabrication of the laminate 1. In addition, hot pressing and the like may be carried out on the laminate 1 as necessary in direction of lamination thereof.

In addition, when fabricating the laminate 1 described above, corresponding tongues 12a may be connected and fixed in advance with a fixing resin, for example, so that the mutual positional relationship of first anode 10 and the second anode 30 is fixed. Similarly, corresponding tongues 22a may be connected and fixed in advance with a fixing resin, for example, so that the mutual positional relationship of the first cathode 20 and the second cathode 40 is fixed. In this case, when arranging the separator 50 on the second cathode 40, the separator 50 and the first anode 10 are arranged between the second cathode 40 and the first cathode 20 in the state of being coiled around the first cathode 20 connected at the portion of the tongue 22a. Similarly, when arranging the separator 50 on the first anode 10, the separator 50 and the first cathode 20 are arranged between the first anode 10 and the second anode 30 in the state of coiling around the second anode 30 connected at the portion of the tongue 12a. As a result, the occurrence of shifting between each of the electrodes during the course of production is more adequately prevented.

After having fabricated the laminate 1 in the manner described above, the external terminal 113 and the external terminal 123 are connected to the resulting laminate 1, and then housed in the case 150 as shown in FIGS. 1 and 2 according to the following procedure.

First, as shown in FIG. 2, the case 150 in the form of a rectangular film is bent at a bending line X-X, and only the sealed portions on both sides of the opposing first film 151 and the second film 152 (other than the sealed portions crossing the external terminals 113 and 123) are heat-sealed over a desired sealing width under predetermined heating conditions using a sealing machine and the like. Continuing, the laminate 1 is inserted inside the case 150 through the portion of the sealed portion where heat sealing has not been carried out. Continuing, electrolyte solution is injected into the case 150 in a vacuum vessel to immerse the laminate 1 in the electrolyte solution. Leads 112 and 122 are then respectively arranged made to extend from within the case 150 to the outside by crossing the sealed portion. The sealed portion of the case 150 is then heat-sealed using a heat sealing machine. At this time, the insulators 114 and 124 of the external terminals 113 and 123 are heat-sealed between the sealed portions. At this time, heat sealing is preferably carried out in a reduced pressure environment such as in a vacuum vessel. This completes fabrication of the lithium ion secondary battery 200.

According to this production method, in addition to realizing superior work efficiency as compared with the case of zigzag folding the separator 50 as in the prior art, each electrode is resistant to shifting during the course of production and in the resulting electrochemical device, thereby adequately suppressing the occurrence of short circuiting.

In addition, in the lithium ion secondary battery 200 as described above, in the case of forming an adhesive layer as previously described on the surface of the separator 50 on the side in the opposite direction from the direction of bending of the folds 60, namely on the surface of the separator 50 in contact with the second anode 30, the first cathode 20 and the second cathode 40 in FIG. 3, the lithium ion secondary battery 200 can also be produced using the production method described below.

First, an adhesive is coated onto one surface of the separator 50 having two folds (first fold 62 and second fold 64) to form an adhesive layer (adhesive layer formation step). Next, the first cathode 20, the second cathode 40 and the second anode 30 are mounted on this adhesive layer in that order from one end of the separator 50 so that the first fold 62 is interposed between the first cathode 20 and the second cathode 40, and the second fold 64 is interposed between the second cathode 40 and the second anode 30 (mounting step).

Next, the first anode 10 is arranged on the surface on the opposite side from the surface of the separator 50 having the adhesive layer that is interposed between the two folds 60 (arrangement step).

Next, the periphery of the first anode 10 is surrounded by the separator 50 by folding the separator 50 at the first fold 62 followed by folding at the second fold 64 (folding step). As a result, electrodes preliminarily mounted on separator 50 through the adhesive layer are respectively arranged at suitable locations, and the laminate 1 is obtained in which the second cathode 40, the first anode 10, the first cathode 20 and the second anode 30 are laminated in that order while interposing the separator 50 between each electrode as shown in (f) of FIG. 13.

According to this production method, since the resulting structure has the first anode 10 surrounded by the separator 50, while the second anode 30, the first cathode 20 and the second cathode 40 are fixed in the separator 50 by means of the adhesive layer, all of the electrodes are resistant to shifting during the course of production and in the resulting electrochemical device, thereby adequately suppressing the occurrence of short circuiting. In addition, in this production method, work efficiency is superior since the adhesive layer is only required to be coated onto one surface of the separator 50.

Although the above has provided a detailed explanation of one preferred embodiment of the electrical chemical device and production method thereof of the present invention, the present invention is not limited to the above-mentioned embodiment. For example, although the explanation of the above-mentioned embodiment explained the case of the electrochemical device being a lithium ion secondary battery, the electrochemical device of the present invention is not limited to a lithium ion secondary battery, but rather may also be a secondary battery other than a lithium ion secondary battery, such as a lithium metal secondary battery, or an electrochemical capacitor such as an electric double layer capacitor, pseudo capacitance capacitor, pseudo capacitor or redox capacitor. Furthermore, in the case of an electrochemical device other than a lithium ion secondary battery, an electrode active material suitable for the respective electrochemical device may be used for the electrode active material. For example, in the case of an electric double layer capacitor, a material such as acetylene black, graphite, black lead or activated charcoal is used for the active material contained in the cathode active material-containing layer and anode active material-containing layer.

### EXAMPLES

Although the following provides a more detailed explanation of the present invention based on examples and comparative examples thereof, the present invention is not limited to the following examples.

### Example 1

First, an anode was fabricated according to the following procedure. First, 90 parts by mass of an anode active material in the form of meso-carbon microbeads (MCMB) (manufactured by Osaka Gas Co., Ltd.), 1 part by mass of graphite (trade name: KS-6, manufactured by Lonza Group, Ltd.), 2 parts by mass of a conductive auxiliary agent in the form of carbon black (trade name: DAB, manufactured by Denki Kagaku Kogyo Co., Ltd.) and 7 parts by mass of a binder in the form of polyvinylidene fluoride (trade name: KYNAR 761, manufactured by Atfina, Inc.) were mixed and dispersed followed by the addition of a suitable amount of solvent in the form of N-methyl-pyrrolidone (NMP) to adjust viscosity and prepare a slurry-like anode coating liquid.

Next, an anode current collector in the form of a copper foil (thickness: 20 μm) was prepared, and the anode coating liquid was coated onto the copper foil by doctor blade coating to a loaded amount of anode active material of 7 mg/cm² and then dried to form an anode active material-containing layer. Next, this anode active material-containing layer was pressed and rolled using a calendar roll to obtain an anode sheet. The resulting anode sheet was stamped out to a shape in which the surface of the active material-containing layer measured 46 mm long×31 mm wide and the current collector had a tongue serving as an external output terminal. Here, an anode in which the active material-containing layer was formed on both sides of the current collector was fabricated for use as the first anode, while an anode in which the active material-containing layer was formed on only one side of the current collector was fabricated for use as the second anode. In addition, the thickness of the first anode was 110 μm, while the thickness of the second anode was 65 μm.

Next, a cathode was fabricated according to the following procedure. First, 91 parts by mass of a cathode active material in the form of lithium cobalt oxide (LiCoO₂) (trade name: Selion, manufactured by AGC Seimi Chemical Co., Ltd.), 4 parts by mass of graphite (trade name: KS-6, manufactured by Lonza Group, Ltd.), 2 parts by mass of a conductive auxiliary agent in the form of carbon black (trade name: DAB, manufactured by Denki Kagaku Kogyo Co., Ltd.) and 3 parts by mass of a binder in the form of polyvinylidene fluoride (trade name: KYNAR 761, manufactured by Atfina, Inc.) were mixed and dispersed followed by the addition of a suitable amount of solvent in the form of N-methyl-pyrrolidone (NMP) to adjust viscosity and prepare a slurry-like cathode coating liquid.

Continuing, a cathode current collector in the form of an aluminum foil (thickness: 15 μm) was prepared, and the cathode coating liquid was coated onto the aluminum foil by doctor blade coating to a loaded amount of cathode active material of 15 mg/cm² and then dried to form a cathode active material-containing layer. Next, this cathode active material-containing layer was pressed and rolled using a calendar roll to obtain a cathode sheet. The resulting cathode sheet was stamped out to a shape in which the surface of the active material-containing layer measured 45 mm long×30 mm wide and the current collector had a tongue serving as an external output terminal. Here, a cathode in which the active material-containing layer was formed on both sides of the current collector was fabricated for use as the first cathode, while a cathode in which the active material-containing layer was formed on only one side of the current collector was fabricated for use as the second cathode. In addition, the thickness of the first cathode was 125 μm, while the thickness of the second cathode was 70 μm.

Next, a porous film made of polyacrylonitrile resin (PAN) (47 mm long×96 mm wide, thickness: 24 μm) was prepared, and perforations were formed at two locations for each interval of 32 mm in the horizontal direction to obtain a separator.

A laminate was then fabricated in accordance with the procedure shown in (a) to (f) of FIG. 13 using the electrodes and separator fabricated as described above. First, as shown in (a) of FIG. 13, the separator was arranged on the second cathode. Next, as shown in (b) of FIG. 13, the first anode was arranged on the separator. Next, as shown in (c) of FIG. 13, the separator was folded at one of the folds where a perforation was formed. Next, as shown in (d) of FIG. 13, the first cathode was arranged on the folded separator. Next, as shown in (e) of FIG. 13, the separator was folded at the other fold where a perforation was formed. Finally, the second anode was arranged on the folded separator. As a result, a laminate was fabricated having a positional relationship for the electrodes and separator as shown in FIG. 3.

Next, the resulting laminate was placed in a case, and an electrolyte, comprising a solvent in the form of propylene carbonate (PC), ethylene carbonate (EC) and diethyl carbonate (DEC) mixed at a volume ratio of 2:1:7, and a solute in the form of 1.5 mol/L LiPF₆, was injected and sealed to obtain a lithium ion secondary battery having the same structure as that shown in FIG. 1. The thickness of the resulting lithium ion secondary battery was 1.0 mm.

### Example 2

A first anode and a first and second cathode were respectively prepared in the same manner as Example 1.

In addition, a porous film made of polyacrylonitrile resin (PAN) (47 mm long×320 mm wide, thickness: 24 μm) was prepared, and perforations were formed at nine locations for each interval of 32 mm in the horizontal direction to obtain a separator.

A laminate having a positional relationship for the electrodes and separator like that shown in FIG. 5 was then fabricated using the electrodes and separator fabricated as described above. In this laminate, the separator was folded in the same direction at two consecutive folds in which perforations were formed from one end thereof so as to form a structure in which one end of the separator surrounded the first anode, and folded at the subsequent folds in the manner of zigzag folding. Furthermore, the structure in which one end of the separator surrounds the first anode was formed using the same procedure as that of Example 1, while the zigzag folded structure was formed so that the anode and cathode are alternately arranged with the separator interposed there between by alternately changing the folding direction of the separator. In addition, the second cathode was used for the electrodes on both ends, while the first anode and the first cathode were used for the other electrodes.

Next, the resulting laminate was placed in a case, and an electrolyte, comprising a solvent in the form of propylene carbonate (PC), ethylene carbonate (EC) and diethyl carbonate (DEC) mixed at a volume ratio of 2:1:7, and a solute in the form of 1.5 mol/L LiPF₆, was injected and sealed to obtain a lithium ion secondary battery. The thickness of the resulting lithium ion secondary battery was 2.0 mm.

### Example 3

A first anode and a first and second cathode were respectively prepared in the same manner as Example 1.

In addition, a porous film made of polyacrylonitrile resin (PAN) (47 mm long×128 mm wide, thickness: 24 μm) was prepared, and perforations were formed at three locations for each interval of 32 mm in the horizontal direction to obtain a separator.

A laminate having a positional relationship for the electrodes and separator like that shown in FIG. 7 was then fabricated using the electrodes and separator fabricated as described above. Namely, the separator was first arranged on the second cathode so that the second cathode was positioned between a first fold and a second fold by folding the separator at first through third folds from one end of the separator using the above folds at the three locations where the perforations were formed. Next, the first anode was respectively arranged between the first fold and the second fold and between the second fold and the third fold on the separator. Next, the separator was folded at the first and third folds. Next, the first cathode was arranged on the separator folded at the first fold. Next, the separator was folded at the second fold. Finally, the second anode was arranged on the folded separator (between the second fold and the third fold) to obtain a laminate.

Next, the resulting laminate was placed in a case, and an electrolyte, comprising a solvent in the form of propylene carbonate (PC), ethylene carbonate (EC) and diethyl carbonate (DEC) mixed at a volume ratio of 2:1:7, and a solute in the form of 1.5 mol/L LiPF₆, was injected and sealed to obtain a lithium ion secondary battery. The thickness of the resulting lithium ion secondary battery was 1.2 mm.

### Example 4

A polarized electrode was first fabricated according to the following procedure. Namely, 87 parts by mass of an active material in the form activated charcoal (trade name: RP-20, manufactured by Kuraray Chemical Co., Ltd.), 3 parts by mass of a conductive auxiliary agent in the form of carbon black (trade name: DAB, manufactured by Denki Kagaku Kogyo Co., Ltd.) and 10 parts by mass of a binder in the form of polyvinylidene fluoride (PVDF) (trade name: KYNAR 761, manufactured by Atfina, Inc.) were mixed and dispersed with a planetary mixer followed by mixing with a suitable amount of solvent in the form of N-methyl-pyrrolidone (NMP) to adjust viscosity and prepare a slurry-like anode coating liquid.

Next, a current collector in the form of etched aluminum foil (thickness 20 μm) was prepared, and the above coating liquid was coated onto this aluminum foil by doctor blade and then dried to form an active material-containing layer. Next, this active material-containing layer was pressed and rolled using a calendar roll to obtain an electrode sheet. The resulting electrode sheet was stamped out to a shape in which the surface of the active material-containing layer measured 12 mm long×16 mm wide and the current collector had a tongue serving as an external output terminal. Here, an electrode in which the active material-containing layer was formed on both sides of the current collector was fabricated for use as the first anode, while an electrode in which the active material-containing layer was formed on only one side of the current collector was fabricated for use as the second anode. In addition, the thickness of the finally obtained active material-containing layer was 20 μm.

In addition, an electrode in which the active material-containing layer was formed on both sides of the current collector was fabricated as the first cathode, while an electrode in which the active material-containing layer was formed on only one side of the current collector was fabricated as the second cathode in the same manner as the above anodes with the exception of stamping out the above-mentioned electrode sheet to a shape in which the surface of the active material-containing layer measured 11.5 mm long×15.5 mm wide and the current collector had a tongue serving as an external output terminal.

Next, a porous film made of polyacrylonitrile resin (PAN) (13 mm long×49.5 mm wide, thickness: 24 μm) was prepared, and perforations were formed at two locations for each interval of 16.5 mm in the horizontal direction to obtain a separator.

A laminate was then fabricated in accordance with the procedure shown in (a) to (f) of FIG. 13 using the electrodes and separator fabricated as described above. First, as shown in (a) of FIG. 13, the separator was arranged on the second cathode. Next, as shown in (b) of FIG. 13, the first anode was arranged on the separator. Next, as shown in (c) of FIG. 13, the separator was folded at one of the folds where a perforation was formed. Next, as shown in (d) of FIG. 13, the first cathode was arranged on the folded separator. Next, as shown in (e) of FIG. 13, the separator was folded at the other fold where a perforation was formed. Finally, the second anode was arranged on the folded separator. As a result, a laminate was fabricated having a positional relationship for the electrodes and separator as shown in FIG. 3.

Next, the resulting laminate was placed in a case, and an electrolyte, comprising a solvent in the form of sulfolane (SL) and diethyl carbonate (DEC) mixed at a volume ratio of 1:1, and a solute in the form of 1.2 mol/L tetraethylammonium tetrafluoroborate (TEA⁺BF₄⁻), was injected and sealed to obtain an electric double layer capacitor having the same structure as that shown in FIG. 7. The thickness of the resulting electric double layer capacitor was 0.5 mm.

### Comparative Example 1

A first and second anode and a first and second cathode were respectively prepared in the same manner as Example 1.

In addition, a porous film made of polyacrylonitrile resin (PAN) (47 mm long×176 mm wide, thickness: 24 μm) was prepared for use as a separator.

A laminate having a positional relationship for the electrodes and separator like that shown in FIG. 9 was then fabricated using the electrodes and separator fabricated as described above. This laminate was formed by employing a structure for the separator consisting of folding the separator in alternately opposite directions at two locations for each interval of 32 mm from one end of the separator so that the anodes and cathodes were alternately arranged with the separator interposed there between. Furthermore, the second anode and the second cathode were used for the electrodes on both ends, while the first anode and the first cathode were used for the other electrodes. Subsequently, the entire outer periphery was covered with the separator, and the separator was fixed with fastening tape having a thickness of 50 μm.

Next, the resulting laminate was placed in a case, and an electrolyte, comprising a solvent in the form of propylene carbonate (PC), ethylene carbonate (EC) and diethyl carbonate (DEC) mixed at a volume ratio of 2:1:7, and a solute in the form of 1.5 mol/L LiPF₆, was injected and sealed to obtain a lithium ion secondary battery. The thickness of the resulting lithium ion secondary battery was 1.2 mm.

### Comparative Example 2

A lithium ion secondary battery was obtained in the same manner as Comparative Example 1 with the exception of making the length of the separator in the horizontal direction 400 mm, folding the separator in alternatively opposite directions at 9 locations for each interval of 32 mm from one end of the separator to impart a zigzag folded shape, and alternately arranging six cathodes and five anodes with the separator interposed there between. Furthermore, the second cathode was used for the electrodes on both ends, while the first anode and the first cathode were used for the other electrodes. The thickness of the resulting lithium ion secondary battery was 2.2 mm.

### Comparative Example 3

A first and second anode and a first and second cathode were respectively prepared in the same manner as Example 1.

In addition, a porous film made of polyacrylonitrile resin (PAN) (47 mm long×96 mm wide, thickness: 24 μm) was prepared, and perforations were formed at two locations for each interval of 32 mm in the horizontal direction to obtain a separator.

A laminate having a positional relationship for the electrodes and separator like that shown in FIG. 8 was then fabricated using the electrodes and separator fabricated as described above. This laminate was fabricated using the same procedure as Example 1 with the exception of employing a zigzag folded structure by bending the separator in alternately opposite directions at two folds where the perforations were formed.

Next, the resulting laminate was placed in a case, and an electrolyte, comprising a solvent in the form of propylene carbonate (PC), ethylene carbonate (EC) and diethyl carbonate (DEC) mixed at a volume ratio of 2:1:7, and a solute in the form of 1.5 mol/L LiPF₆, was injected and sealed to obtain a lithium ion secondary battery. The thickness of the resulting lithium ion secondary battery was 1.0 mm.

<Measurement of Discharge Capacity and Volume Energy Density>

The lithium ion secondary batteries obtained in Examples 1 to 3 and Comparative Examples 1 to 3 were charged at a constant current (CC) equivalent to 0.5 C A and constant voltage (CV) of 4.2 V, followed by pausing charging for 10 minutes and then discharging to 3 V at a current equivalent to 0.5 C A. The above charging and discharging were repeated five times, and discharge capacity and volume energy density were measured. In addition, the electric double layer capacitor obtained in Example 4 was charged at a constant current (CC) of 5 nA and constant voltage (CV) of 3 V, and then discharged to 2 V at a current of 5 mA immediately after completion of charging. The above charging and discharging were repeated five times, and discharge capacity and volume energy density were measured. Those results are shown in Table 1.

<Measurement of Self-Discharge Retained Voltage>

Five each of the lithium ion secondary batteries of Examples 1 to 3 and Comparative Examples 1 to 3 and the electric double layer capacitor of Example 4 were fabricated according to the above-mentioned production method. The lithium ion secondary batteries obtained in Examples 1 to 3 and Comparative Examples 1 to 3 were charged at a constant current (CC) equivalent to 0.5 C A and constant voltage (CV) of 3.85 V, voltage after allowing to stand for 1 week was measured, and the average value of the five samples was used as the average self-discharge retained voltage. In addition, the electric double layer capacitor obtained in Example 4 was charged at a constant current (CC) of 5 mA and constant voltage (CV) of 2 V, voltage after allowing to stand for 2 hours was measured, and the average value of the five samples was used as the average self-discharge retained voltage. The presence or absence of soft short circuiting was able to be evaluated according to this self-discharge retained voltage, with a large reduction rate from the charging voltage indicating a higher rate of occurrence of soft short circuiting. Those results are shown in Table 1.

TABLE 1

| | | | | | Comp. | Comp. | Comp. |
|---|---|---|---|---|---|---|---|
| | Example 1 | Example 2 | Example 3 | Example 4 | Ex. 1 | Ex. 2 | Ex. 3 |
| No. of electrodes | 4 | 11 | 5 | 4 | 4 | 11 | 4 |
| No. of cell layers | 3 | 10 | 4 | 3 | 3 | 10 | 3 |
| Device thickness | 1.0 | 2.0 | 1.2 | 0.5 | 1.2 | 2.2 | 1.0 |
| (mm) | | | | | | | |
| Discharge | 75 mAh | 250 mAh | 100 mAh | 320 mF | 73 mAh | 245 mAh | 70 mAh |
| capacity | | | | | | | |
| Volume energy | 143 | 236 | 159 | 0.71 | 116 | 213 | 133 |
| density (Wh/L) | | | | | | | |
| Average self- | 3.78 | 3.77 | 3.77 | 1.95 | 3.58 | 3.57 | 3.50 |
| discharge retained | | | | | | | |
| voltage (V) | | | | | | | |

What is claimed is:

1. An electrochemical device, comprising:
a first anode and a first cathode,
a single continuous separator provided between the first anode and the first cathode and folded so as to be arranged on an opposite side of the first anode to the first cathode and on an opposite side of the first cathode to the first anode, and
an electrolyte in contact with the separator, the first anode and the first cathode, wherein
the separator has a shape that surrounds the periphery of the first anode or the first cathode by being folded, in the same direction, at two folds consecutive from one end of the separator.

2. The electrochemical device according to claim 1, comprising a second cathode arranged on the outer peripheral surface of the separator so as to oppose the first anode, with the separator interposed therebetween, and/or a second anode arranged on the outer peripheral surface of the separator so as to oppose the first cathode, with the separator interposed therebetween.

3. The electrochemical device according to claim 1, comprising two or more of the first anode and/or the first cathode,
the separator having a shape that surrounds the periphery of the first anode or the first cathode by being folded, in the same direction, at two folds consecutive from another end on the opposite side to the one end of the separator.

4. An electrochemical device, comprising:
a first unit having a first anode, a first cathode, a single continuous separator provided between the first anode and the first cathode and folded so as to be arranged on an opposite side of the first anode to the first cathode and on an opposite side of the first cathode to the first anode, a second cathode arranged on the outer peripheral surface of the separator so as to oppose the first anode with the separator interposed therebetween, and an electrolyte in contact with the separator, the first anode, the first cathode and the second cathode, the separator having a shape that surrounds the periphery of the first anode or the first cathode by being folded in the same direction at two folds consecutive from one end of the separator;
a second unit having a first anode, a first cathode, a single continuous separator provided between the first anode and the first cathode and folded so as to be arranged on an opposite side of the first anode to the first cathode and on an opposite side of the first cathode to the first anode, a second anode arranged on the outer peripheral surface of the separator so as to oppose the first cathode with the separator interposed therebetween, and an electrolyte in contact with the separator, the first anode, the first cathode and the second anode, the separator having a shape that surrounds the periphery of the first anode or the first cathode by being folded in the same direction at two folds consecutive from one end of the separator,
the electrochemical device having a structure in which the first unit and second unit are alternately laminated.

5. The electrochemical device according to claim 1, wherein the two folds consecutive from the end of the separator are formed at equal intervals.

6. The electrochemical device according to claim 4, wherein the two folds consecutive from the end of the separator are formed at equal intervals.

7. The electrochemical device according to claim 1, wherein severed portions and non-severed portions are arranged in the folds of the separator, along the folds.

8. The electrochemical device according to claim 4, wherein severed portions and non-severed portions are arranged in the folds of the separator, along the folds.

9. A production method for an electrochemical device provided with a first anode, a first cathode, a single continuous separator provided between the first anode and the first cathode and folded so as to be arranged on an opposite side of the first anode to the first cathode and on an opposite side of the first cathode to the first anode, and an electrolyte in contact with the separator, the first anode and the first cathode, the separator having a shape that surrounds the periphery of the first anode or the first cathode by being folded in the same direction at two folds consecutive from one end of the separator,
the method comprising:
a first arrangement step, in which one of either the first anode or the first cathode is arranged on a surface between the two folds in the separator,
a first folding step, in which the separator is folded at one of the folds and the folded separator is arranged on the first anode or first cathode arranged in the first arrangement step,
a second arrangement step, in which the other first anode or first cathode is arranged on the folded separator, and
a second folding step, in which the separator is folded at the other fold and the folded separator is arranged on the first anode or first cathode arranged in the second arrangement step.

10. The production method of an electrochemical device according to claim 9, wherein the electrochemical device is provided with a second cathode arranged on the outer peripheral surface of the separator so as to oppose the first anode with the separator interposed therebetween, and/or a second anode arranged on the outer peripheral surface of the separator so as to oppose the first cathode with the separator interposed therebetween,
the method further comprising a connection step in which the first anode and the second anode and/or the first cathode and the second cathode are partially connected so that the mutual positional relationship thereof is fixed prior to the first arrangement step.
